(19) United States
(12) Patent Application Publication
(10) Pub. No.: US 2017/0107961 A1
(43) Pub. Date: Apr. 20, 2017

(54) GAUGING APPARATUS

(71) Applicant: Caterpillar Inc., Peoria, IL (US)

(72) Inventors: Eli Morelos, Nuevo Laredo (MX); Eduardo E. Gonzalez Gonzalez, Nuevo Laredo (MX)

(73) Assignee: Caterpillar Inc., Peoria, IL (US)

(21) Appl. No.: 14/886,166

(22) Filed: Oct. 19, 2015

(51) Int. Cl. F02M 65/00

(52) U.S. Cl. CPC F02M 65/00

(57) ABSTRACT

A gauging apparatus for measuring a dimension of a component is provided. The gauging apparatus includes an upper nest configured to move along a first axis. The upper nest includes a first frame member and a second frame member. The second frame member is spaced apart from the first frame member along the first axis. The upper nest also includes a damping element disposed between the first frame member and the second frame member. The gauging apparatus also includes a lower nest fixedly coupled to a base of the gauging apparatus. The upper nest and the lower nest are configured to receive the component during the measuring thereof.

### TECHNICAL FIELD

The present disclosure relates to a gauging apparatus, and more particularly to a gauging apparatus and a method of measuring a dimension of a component using the gauging apparatus.

### BACKGROUND

A gauging apparatus is generally used to measure one or more dimensions of a test unit. In some examples, the gauging apparatus tests whether the dimension of the test unit is within a predefined limit. Gauging apparatus currently available in the market may not provide sufficient accuracy and may not reflect actual measurement values due to repeatability issues. Further, some gauging apparatus have a very low First Time Pass Rate (FTPR) and do not exhibit high repeatability. Additionally, one or more components of known gauging apparatus may exert excessive pressure on the test unit, resulting in damage to the unit.

U.S. Pat. No. 2,944,342 describes an apparatus for checking or measuring a straight series of two or more grooves or serrations which are geometrically similar in shape, which have flanks which converge, at least in part, inwardly towards the bottom of the groove or serration, and in which the pitch between any pair of adjacent grooves or serrations is constant along the length of the grooves or serrations.

### SUMMARY OF THE DISCLOSURE

In one aspect of the present disclosure, a gauging apparatus for measuring a dimension of a component is provided. The gauging apparatus includes an upper nest configured to move along a first axis. The upper nest includes a first frame member and a second frame member. The second frame member is spaced apart from the first frame member along the first axis. The upper nest also includes a damping element disposed between the first frame member and the second frame member. The gauging apparatus includes a lower nest fixedly coupled to a base of the gauging apparatus. The upper nest and the lower nest are configured to receive the component during the measuring thereof.

In another aspect of the present disclosure, a method of measuring a component using a gauging apparatus is provided. The method includes positioning the component within a lower nest of the gauging apparatus. The method also includes adjusting a position of an upper nest of the gauging apparatus by operating the lever of the gauging apparatus, the upper nest including a first frame member and a second frame member. The method further includes clamping the component between the upper nest and the lower nest, based on the adjustment. The method includes actuating a sensing element disposed with the upper nest to measure a dimension of the component.

In yet another aspect of the present disclosure, a gauging apparatus for measuring a dimension of a component is provided. The gauging apparatus includes a frame and a clamping arrangement for clamping the component. The clamping arrangement includes an upper nest slidably coupled to the frame. The upper nest is configured to move along a first axis. The upper nest includes a first frame member and a second frame member. The second frame member is spaced apart from the first frame member along the first axis. The upper nest also includes a damping element disposed between the first frame member and the second frame member, the damping element including a spring. The clamping arrangement also includes a lower nest fixedly coupled to a base of the gauging apparatus. The clamping arrangement further includes a lever configured to move the upper nest along the first axis for clamping the component between the upper nest and the lower nest. The gauging apparatus includes a sensing element disposed in the upper nest of the gauging apparatus, the sensing element configured to measure the dimension of the component.

Other features and aspects of this disclosure will be apparent from the following description and the accompanying drawings.

### BRIEF DESCRIPTION OF THE DRAWINGS

FIG. 1 is a perspective view of a gauging apparatus, according to one embodiment of the present disclosure;

FIG. 2 is a perspective view of an upper nest of the gauging apparatus of FIG. 1;

FIG. 3 is a perspective view of a lower nest of the gauging apparatus of FIG. 1;

FIG. 4 is a perspective view of the gauging apparatus during a measurement of a component; and

FIG. 5 is a flowchart for a method of testing the component using a gauging apparatus.

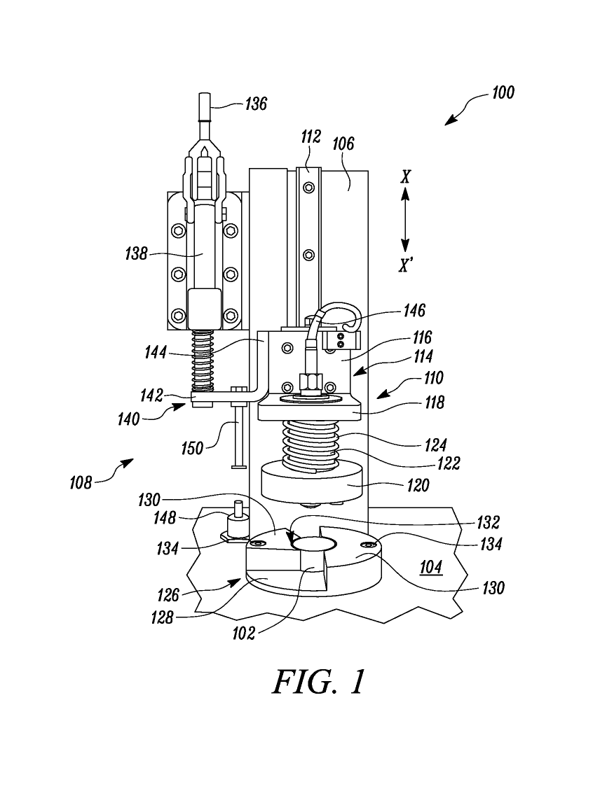

### DETAILED DESCRIPTION

Wherever possible, the same reference numbers will be used throughout the drawings to refer to the same or the like parts. FIG. 1 is a perspective view of a gauging apparatus 100, according to one embodiment of the present disclosure. The gauging apparatus 100 is used to measure a dimension of a component 102. The dimension may include a depth, thickness, length, etc. of the component 102. In one example, the gauging apparatus 100 may measure one or more components of a fuel injector. For example, the gauging apparatus 100 may test dimensions of a shim, pin, or lower plate of the fuel injector. The application of the gauging apparatus 100 disclosed herein may be extended to measuring dimensions of different components of a machine (not shown), without any limitations.

The gauging apparatus 100 includes a base 104. The gauging apparatus 100 also includes a frame 106 mounted on the base 104. The frame 106 is mounted perpendicular to the base 104, and extends along a first axis X-X′. The gauging apparatus 100 includes a clamping arrangement 108. The clamping arrangement 108 clamps the component 102 during a measurement process of the dimension of the component 102.

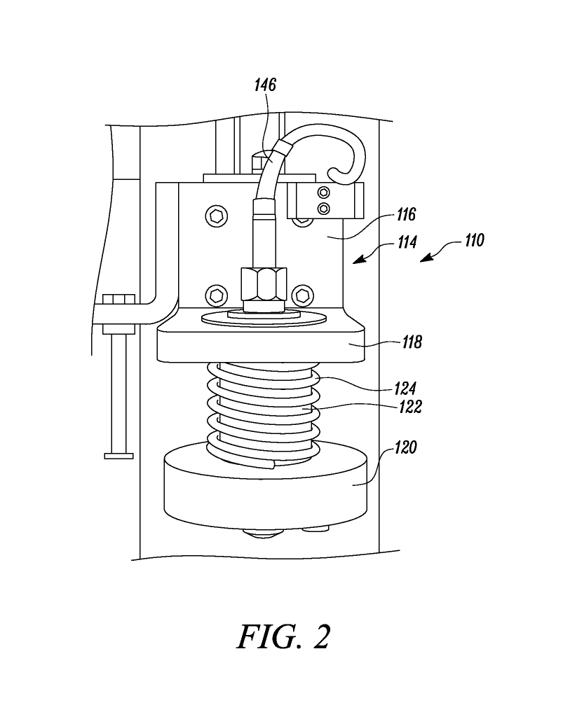

Referring to FIGS. 1 and 2, the clamping arrangement 108 includes an upper nest 110. The upper nest 110 is slidably coupled to the frame 106. The upper nest 110 moves vertically along the first axis X-X′. A rail 112 is coupled to the frame 106. The upper nest 110 slides along a length of the rail 112. The upper nest 110 includes a first frame member 114. The first frame member 114 is L-shaped. A first portion 116 of the first frame member 114 is slidably coupled to the rail 112. A second portion 118 of the first frame member 114 is perpendicular to the first portion 116. The second portion 118 of the first frame member 114 includes an opening (not shown). The opening is embodied as a through-hole extending along the first axis X-X′. The first and second portions 116, 118 of the upper nest 110 are square shaped. Alternatively, the first and second portions 116, 118 may have a different shape, without limiting the scope of the present disclosure.

The upper nest 110 also includes a second frame member 120. The second frame member 120 is spaced apart from the second portion 118 of the first frame member 114, along the first axis X-X′. In one example, the second frame member 120 is disc shaped. Alternatively, the second frame member 120 may be rectangular or square shaped, or any other desired shape suitable to the application. The second frame member 120 includes an opening (not shown). The opening is embodied as a through-hole. The openings provided in the second portion 118 of the first frame member 114 and the second frame member 120 are aligned to receive a rod member 122. The rod member 122 extends along the first axis X-X′. The rod member 122 is cylindrical in shape, and defines a hollow portion.

A damping element 124 is provided between the first frame member 114 and the second frame member 120. The damping element 124 dampens shocks and vibrations during the clamping of the component 102. The damping element 124 extends along the first axis X-X′ and surrounds a portion of the rod member 122. The damping element 124 allows clamping and retention of the component 102 between the upper nest 110 and a lower nest 126, by exerting a clamping force on the component 102. During the clamping of the component 102, the damping element 124 retracts to apply the clamping force on the component 102. In one example, the damping element 124 is embodied as a spring. The damping element 124 may include an open coil spring. Alternatively, the damping element 124 may include a different element that is capable of absorbing shocks experienced by the first and/or second frame members 114, 120.

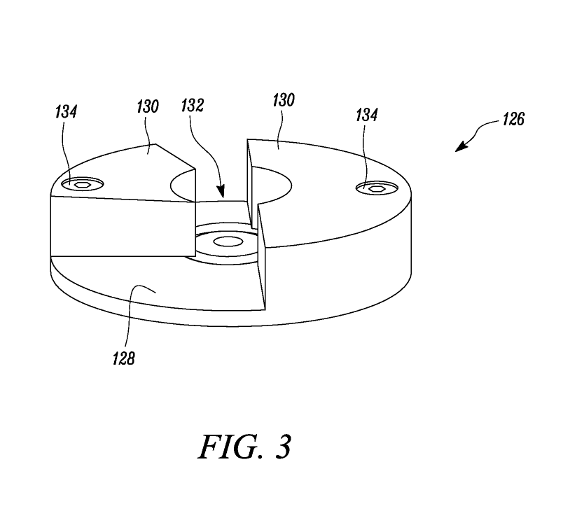

Referring to FIGS. 1 and 3, the clamping arrangement 108 includes a lower nest 126. The upper nest 110 and the lower nest 126 together clamp the component 102 during the measurement process of the dimension of the component 102. The lower nest 126 includes a first plate 128. The first plate 128 may be disc shaped. The lower nest 126 also includes a number of projections 130 extending from the first plate 128. A thickness of the projections 130 is greater than a thickness of the first plate 128. The number of projections 130 forms a hollow portion 132 within the lower nest 126. It is also contemplated that the lower nest includes a single projection 130 having an opening that defines the hollow portion 132. The component 102 is received and held within the hollow portion 132 defined by the projections 130. In the illustrated example, the hollow portion 132 defined by the projections 130 is circular in shape. However, a shape of the hollow portion 132 may be varied by modifying a shape of the projections 130 to receive components that are non-circular in shape.

The lower nest 126 is fixedly coupled to the base 104 of the gauging apparatus 100. In one example, the lower nest 126 may be bolted to the base 104. In such an example, the projections 130 and the first plate 128 may include through holes. The through holes provided in the projections 130 and the first plate 128 may be aligned with openings in the base 104 to receive mechanical fasteners 134. The mechanical fasteners 134 may include any one of a bolt, screw, rivet, pin, and the like. In other examples, the lower nest 126 may be welded to the base 104. It should be noted that any mechanical fastening process may be used to couple the lower nest 126 with the base 104, without limiting the scope of the present disclosure.

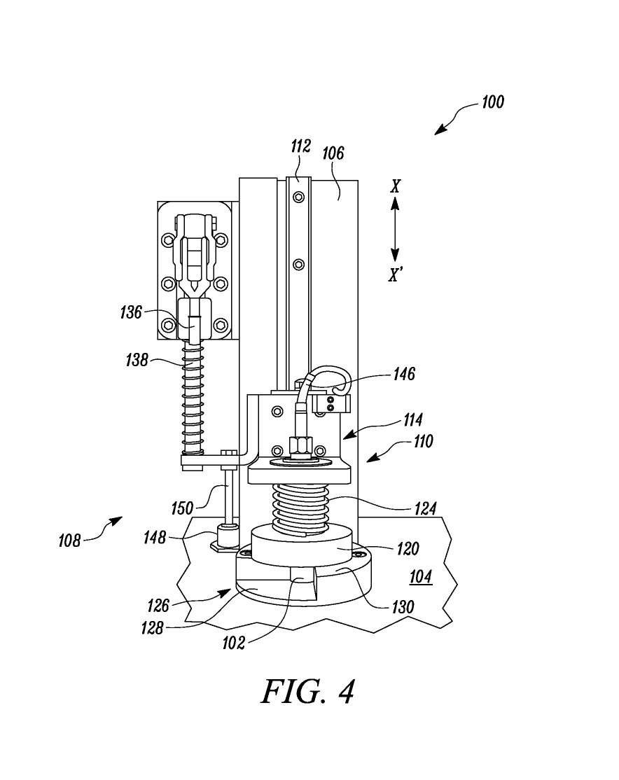

Referring to FIGS. 1 and 4, the clamping arrangement 108 includes a lever 136. The lever 136 is operated to clamp the component 102 between the upper and lower nests 110, 126. The lever 136 may be manually operated by a person in charge of the measurement process. As shown in FIG. 4, movement of the lever 136 allows clamping of the component 102 between the upper nest 110 and the lower nest 126. More particularly, the lever 136 effectuates the movement of the upper nest 110, along the first axis X-X′. Based on the operation of the lever 136, the upper nest 110 slides along the rail 112 and moves towards the lower nest 126. Further, the lever 136 is operated till the second frame member 120 of the upper nest 110 contacts the lower nest 136. When the second frame member 120 and the lower nest 136 are in contact, the damping element 124 applies the clamping force for the clamping of the component 102.

The clamping arrangement 108 includes a bar member 138. One end of the bar member 138 is coupled to the lever 136. Further, an angled portion 140 is coupled to another end of the bar member 138. A first arm 142 of the angled portion 140 is coupled to the bar member 138, whereas a second arm 144 of the angled portion 140 is coupled with the first portion 116 of the first frame member 114. The bar member 138 and the angled portion 140 together cause the upper nest 110 to move, based on the operation of the lever 136.

Referring to FIGS. 1 and 2, the gauging apparatus 100 includes a sensing element 146. The sensing element 146 measures the dimension of the component 102, and generates a signal corresponding to the dimension of the component 102. More particularly, the sensing element 146 measures the dimension of the component 102 based on the movement of the upper nest 110 towards the lower nest 126. The sensing element 146 may include a Linear Variable Displacement Transducer (LVDT). In an alternate example, the sensing element 146 may include other sensors, based on system requirements. The sensing element 146 is disposed in the upper nest 110 of the gauging apparatus 100. The second portion 118 of the first frame member 114, the hollow portion of the rod member 122, and the second frame member 120 are aligned to receive the sensing element 146 therein. In one example, the sensing element 146 may be threadably coupled with the upper nest 110. In other examples, a different coupling method may be used to couple the sensing element 146 with the upper nest 110, without limiting the scope of the present disclosure.

As shown in FIG. 1, the gauging apparatus 100 includes a shock absorber 148. The shock absorber 148 is mounted on the base 104. The shock absorber 148 is disposed adjacent to the lower nest 126. The shock absorber 148 dampens shocks that are created during the clamping of the component 102. The shock absorber 148 also acts as a limit switch to prevent a travel of the upper nest 110 beyond a predefined limit. A shaft 150 is coupled to the first arm 142 of the angled portion 140. When the lever 136 is operated to move the upper nest 110, the shaft 150 contacts the shock absorber 148 thereby preventing the upper nest 110 to travel beyond the predefined limit. The predefined limit of travel of the upper nest 110 may be based on a size of the component being measured. The shock absorber 148 may embody any known shock absorbing device that is capable of damping shocks and vibrations, such as the vibrations created during the clamping of the component 102.

During the measurement of the component 102, the component 102 is aligned and positioned within the hollow portion 132 of the lower nest 126. After positioning the component 102 within the lower nest 126, the personnel operates the lever 136 so that the second frame member 120 of the upper nest 110 moves towards and contacts the lower nest 126. Further, based on the actuation of the sensing element 146 and the movement of the upper nest 110 towards the lower nest 126, the sensing element 146 measures and generates signals corresponding to the dimension of the component 102. The signals generated by the sensing element 146 may be received by a control module (not shown). The control module may be communicably coupled with the sensing element 146. The control module processes the signals received from the sensing element 146 and displays the same on an output module (not shown). The output module provides a notification to the personnel pertaining to the measured dimensions of the component 102. In one example, the output module may indicate whether the dimension of the component 102 lies within a predefined range.

The output module may embody a visual output or an audio output. In case of an audible output, an audio clip may be heard thereby notifying the personnel regarding a value of the dimension of the component 102. In another example, wherein the output module is embodied as a visual output, the output module may include any one of a digital display device, a Liquid Crystal Display (LCD) device, a Light-Emitting Diode (LED) device, a cathode ray tube (CRT) monitor, a touchscreen device, or any other display device known in the art. In one example, the output module may notify the personnel regarding the value of the dimension of the component 102 through a text message. It should be noted that the output module may include any other means other than those listed above.

The components of the gauging apparatus 100, for example the upper nest 110, the lower nest 126, the frame 106, and the base 104 may be made from any metal known in the art. For example, the components of the gauging apparatus 100 may be made of cast iron, without limiting the scope of the present disclosure. Further, the components of the gauging apparatus 100 may be manufactured using any additive or subtractive manufacturing process known in the art.

### INDUSTRIAL APPLICABILITY

The gauging apparatus 100 of the present disclosure includes the movable upper nest 110 provided with the damping element 124. The movable upper nest 110 and the damping element 124 together reduce measurement variation. Also, the damping element 124 contributes to a stable operation of the gauging apparatus 100 thereby increasing First Time Pass Rate (FTPR). Additionally, the gauging apparatus 100 reduces/eliminates any damage to the component under measurement. Further, the lower nest 126 of the gauging apparatus 100 disclosed herein is appropriately sized so that the component 102 does not move during the measurement process.

The gauging apparatus 100 includes the shock absorber 148. The shock absorber 148 reduces/eliminates any impact on the component 102 during the measurement process. The gauging apparatus 100 disclosed herein is less susceptible to errors and provides accurate readings of the dimensions of the component 102. Further, the gauging apparatus 100 is easy to use, and has improved repeatability as compared to other gauging systems.

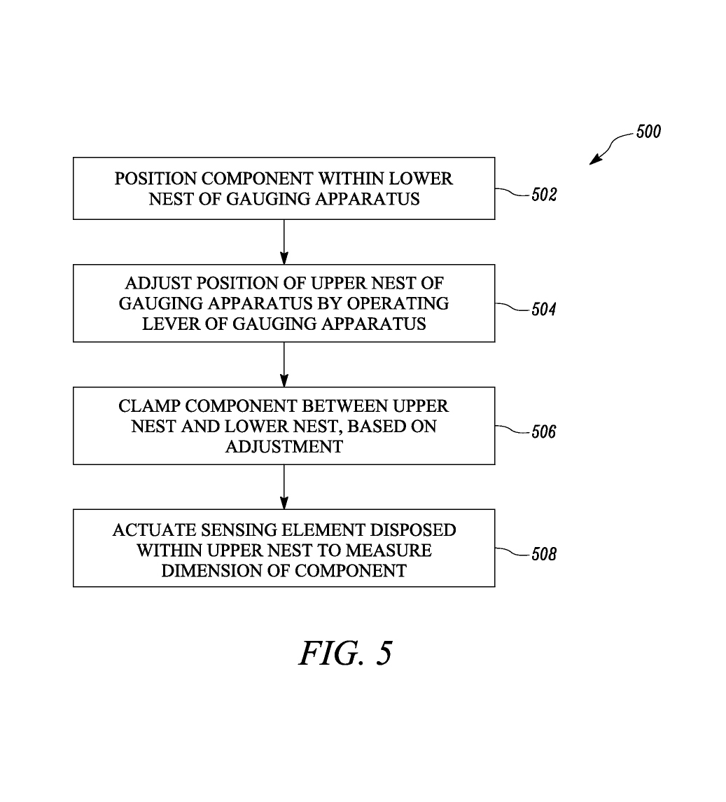

FIG. 5 is a flowchart for a method 500 of measuring the component 102 using the gauging apparatus 100. At step 502, the component 102 is positioned within the lower nest 126 of the gauging apparatus 100. At step 504, the position of the upper nest 110 of the gauging apparatus 100 is adjusted by operating the lever 136 of the gauging apparatus 100. More particularly, the personnel operates the lever 136 to slide the upper nest 110 along the first axis X-X′. The upper nest 110 includes the first frame member 114 and the second frame member 120. Further, the damping element 124 is provided between the first frame member 114 and the second frame member 120 of the upper nest 110.

At step 506, the component 102 is clamped between the upper nest 110 and the lower nest 126, based on the adjustment of the upper nest 110. At step 508, the sensing element 146 is disposed within the upper nest 110, and is actuated to measure the dimension of the component 102. The sensing element 146 is adapted to measure the dimension of the component 102 based on the movement of the upper nest 110 towards the lower nest 126. The sensing element 146 includes the LVDT. Further, the shock absorber 148 is provided adjacent to the lower nest 126. The shock absorber 148 dampens shocks created during the clamping of the component 102.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A gauging apparatus for measuring a dimension of a component, the gauging apparatus comprising:
an upper nest configured to move along a first axis, the upper nest comprising:
a first frame member;
a second frame member spaced apart from the first frame member along the first axis; and
a damping element disposed between the first frame member and the second frame member; and
a lower nest fixedly coupled to a base of the gauging apparatus,
wherein the upper nest and the lower nest are configured to receive the component during the measuring thereof.

2. The gauging apparatus of claim 1, further comprising a shock absorber disposed adjacent to the lower nest, the shock absorber configured to dampen shocks during the clamping of the component.

3. The gauging apparatus of claim 1, wherein the damping element includes a spring.

4. The gauging apparatus of claim 1, further comprising a sensing element disposed in the upper nest, the sensing element configured to measure the dimension of the component.

5. The gauging apparatus of claim 4, wherein the sensing element is a Linear Variable Displacement Transducer (LVDT).

6. The gauging apparatus of claim 1, wherein the upper nest is slidably coupled to a frame of the gauging apparatus.

7. The gauging apparatus of claim 1, further comprising a lever configured to move the upper nest along the first axis for clamping the component between the upper nest and the lower nest.

8. The gauging apparatus of claim 7, wherein movement of the lever of the gauging apparatus causes the component to be clamped between the upper nest and the lower nest.

9. The gauging apparatus of claim 1, wherein the gauging apparatus is configured to measure dimensions of one or more components of a fuel injector.

10. A method for measuring a component using a gauging apparatus, the method comprising:
positioning the component within a lower nest of the gauging apparatus;
adjusting a position of an upper nest of the gauging apparatus by operating the lever of the gauging apparatus, the upper nest including a first frame member and a second frame member;
clamping the component between the upper nest and the lower nest, based on the adjustment; and
actuating a sensing element disposed within the upper nest to measure a dimension of the component.

11. The method of claim 10, wherein the adjusting step further includes:
sliding the upper nest along the first axis.

12. The method of claim 10, wherein the sensing element is a Linear Variable Displacement Transducer (LVDT).

13. The method of claim 10, wherein a damping element is provided between the first frame member and the second frame member of the upper nest.

14. The method of claim 10, further comprising damping shocks created during the clamping step using a shock absorber disposed adjacent to the lower nest.

15. A gauging apparatus for measuring a dimension of a component, the apparatus comprising:
a frame;
a clamping arrangement for clamping the component, the clamping arrangement comprising:
an upper nest slidably coupled to the frame, the upper nest configured to move along a first axis, the upper nest comprising:
a first frame member;
a second frame member spaced apart from the first frame member along the first axis; and
a damping element disposed between the first frame member and the second frame member, the damping element including a spring;
a lower nest fixedly coupled to a base of the gauging apparatus; and
a lever configured to move the upper nest along the first axis for clamping the component between the upper nest and the lower nest; and
a sensing element disposed in the upper nest of the gauging apparatus, the sensing element configured to measure the dimension of the component.

16. The gauging apparatus of claim 15, wherein the sensing element is a Linear Variable Displacement Transducer (LVDT).

17. The gauging apparatus of claim 15, further comprising a shock absorber disposed adjacent to the lower nest, the shock absorber configured to dampen shocks during the clamping of the component.

18. The gauging apparatus of claim 15, wherein the gauging apparatus is configured to measure dimensions of one or more components of a fuel injector.

19. The gauging apparatus of claim 15, wherein the lever of the gauging apparatus is manually operated to clamp the component between the upper nest and the lower nest.
